(19) United States
(12) Patent Application Publication
(10) Pub. No.: US 2006/0164822 A1
(43) Pub. Date: Jul. 27, 2006

(54) Display console panel for controller

(75) Inventors: Hideo Kobayashi, Yamanashi (JP); Kunio Kanda, Gotenba-shi (JP)

Correspondence Address: STAAS & HALSEY LLP, SUITE 700, 1201 NEW YORK AVENUE, N.W., WASHINGTON, DC, 20005, US

(73) Assignee: FANUC LTD, Yamanashi (JP)

(21) Appl. No.: 11/334,523

(22) Filed: Jan. 19, 2006

(30) Foreign Application Priority Data
Jan. 21, 2005 (JP) 14643/2005

(51) Int. Cl. F21V 33/00

(52) U.S. Cl. 362/85

(57) ABSTRACT

A display console panel which can be connected to and communicated with a controller to exchange data with the numerical control apparatus has a casing in which a touch panel allowing an user to manually perform various setting operations and a data inputting operation, an organic EL display unit for displaying data, a solar battery for power supply generation, and a control circuit for performing a data input/output operation or display control of the organic EL display device.

### BACKGROUND OF THE INVENTION

1. Field of the Invention

The present invention relates to a display console panel used in a controller such as a numerical control apparatus (CNC) and robot controller.

2. Description of the Related Art

Controllers, such as numerical control apparatuses and robot controllers, generally have a manual data input device with display, such as an LCD/MDI (Liquid Crystal Display/Manual Data Input). Various setting operations or operations for inputting/outputting data and updating system software are performed by using such a manual data input device with display. However, numerical control apparatuses (for example, motion controllers) or the like for controlling a single axis motor do not have such a LCD/MDI or the like, in general, and are not designed to allow such a LCD/MDI or the like to be connected to themselves.

In such a controller, a display console panel which can be detachably attached to a controller is connected to the controller to carry out various setting operations and operations for inputting data. An LCD is generally used as a display device in the display console panel. In general, the display console panel is supplied with power from the controller.

As described above, in the display console panel used in the conventional controller, the LCD serving as the display device has high power consumption, so that the display console panel has to be supplied with power from the controller when it is used. Accordingly, the display console panel is usually connected to the controller by means of a line. In addition, since the display console panel includes a display unit and operation keys, the overall size of the display console panel naturally increases, and the display console panel is inconvenient to be carried on.

Although not in the technical field of controllers, a watch which uses an EL (Electro Luminescence) panel for illumination and a solar battery as a power source is known (for example, see Japanese Patent Application Laid-Open No. 2002-148361).

### SUMMARY OF THE INVENTION

A display console panel according to the present invention can be connected to and communicated with a controller, such as a numerical control apparatus and robot controller, to exchange data with the controller. The display console panel comprises: a touch panel allowing an user to manually perform various setting operations and a data inputting operation; an organic EL display unit for displaying data; a solar battery for power supply generation; a control circuit for performing a data input/output operation or display control of the organic EL display device; and a casing to accommodate the touch panel, the organic EL display device, the solar battery, and the control circuit in piles.

In the display console panel according to the present invention, the touch panel may be accommodated in the casing in a state where the touch panel is exposed from an upper portion in the casing, and wherein, in the casing, the organic EL display device is arranged on the back of the touch panel, the solar battery is arranged on the back of the organic EL display device, and the control circuit is arranged on the back of the solar battery.

In the display console panel according to the present invention, the touch panel may be accommodated in the casing 2 in a state where the touch panel 3 is exposed from the upper portion of the casing 2, and wherein, in the casing, the organic EL display device is arranged on the back of the touch panel, the control circuit is arranged on the back of the organic EL display device, and the solar battery is arranged on and exposed from the bottom of the casing.

Further, in the display console panel according to the present invention, the touch panel maybe accommodated in a state where the touch panel is exposed from an upper portion in the casing, and wherein, in the casing, the organic EL display device is arranged on the back of the touch panel, the control circuit is arranged on the back of the organic EL display device, and the solar battery is arranged on an upper edge of the casing.

According to the present invention, as an organic EL display device of low power consumption is used in a display of a consol display panel, it is possible to reduce power consumption of the display console. The use of a battery as a power source allows renders an external power supply unnecessary. Since a touch panel is employed as a manual data input device, the display is made integral with the display consol panel, allowing reduction of an overall size of the display console panel. Furthermore, as wireless communication is used as a means for communicating with a controller, such as a numerical controller and robot controller, it is unnecessary to connect the display console panel to the controller by means of a line.

### BRIEF DESCRIPTION OF THE DRAWINGS

The above and other objects and characteristic features of the present invention will be apparent from explanations of the following embodiments with reference to the accompanying drawings. Of these drawings:

FIG. 1 is a schematic sectional view showing the configuration of a first embodiment of a display console panel according to the present invention;

FIG. 2 is a block diagram showing an electric circuit arranged on the display console panel in FIG. 1;

FIG. 3 is a schematic sectional view showing the configuration of a second embodiment of the display console panel according to the present invention;

FIG. 4 is a schematic sectional view showing the configuration of a third embodiment of the display console panel according to the present invention;

FIG. 5 is a plan view of the display console panel shown in FIG. 4; and

FIG. 6 is a plan view showing a modification of the display console panel shown in FIG. 5.

### DETAILED DESCRIPTION OF THE PREFERRED EMBODIMENTS

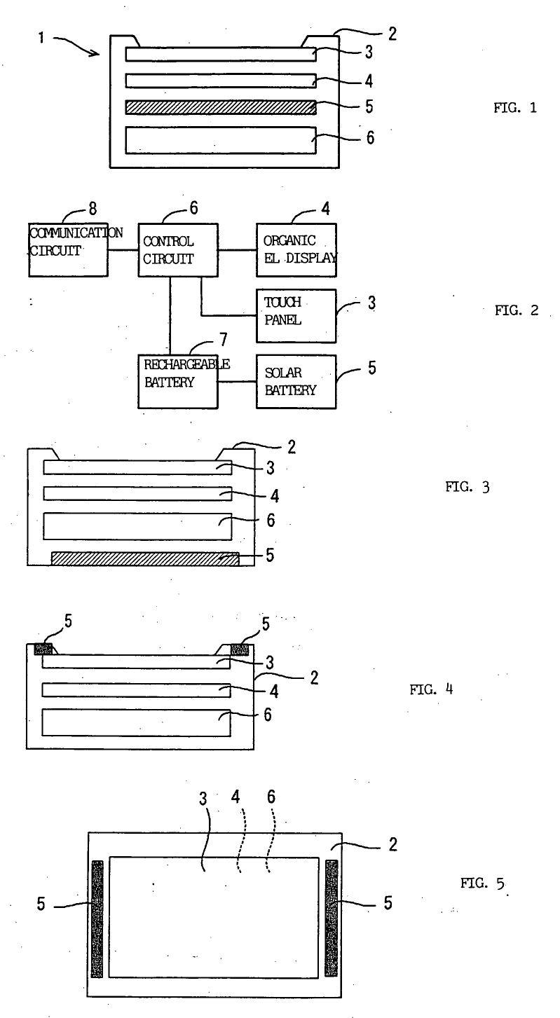

FIG. 1 is a schematic sectional view showing the configuration of the first embodiment of a display console panel according to the present invention.

In a display console panel 1 according to one embodiment of the present invention, a touch panel 3 allowing an user to manually perform various setting operations and a data inputting operation is accommodated in a box-like casing 2 in a state where the touch panel 3 is exposed from the upper portion of the casing 2. Further, in the casing 2, an organic EL display unit 4 for data displaying is arranged on the back (lower surface) of the touch panel 3, a solar battery 5 serving as a power source is arranged on the back of the organic EL display unit 4, and a control circuit 6 for data inputting/outputting and display control of the organic EL display unit 4 is arranged on the back of the solar battery 5.

The display console panel 1 for a controller is constituted such that substrates of the touch panel 3, the organic EL display unit 4, the solar battery 5 and the control circuit 6 are stacked and accommodated in one casing 2. The display console panel 1 shown in FIG. 1 can be connected to a controller (not shown), such as a numerical control apparatus or robot controller, through a communication circuit to exchange data with the controller.

FIG. 2 is a block diagram showing an electric circuit arranged on the display console panel 1. A communication circuit 8 for communication with a controller, such as a numerical controller including a motion controller for control of a motor, and a robot controller, is connected to the control circuit 6. The control circuit 6 can communicate with the controller with the use of wireless communication system through the communication circuit 8. However, the control circuit 6 may communicate with the controller through a wire connection using a connecting connector or the like, in place of wireless communication.

The display console panel 1 is connected to the controller, so that various setting operations, data inputting, updating of system software, and the like are carried out through the touch panel 3. The control circuit 6 executes input/output control of data or display control of the organic EL display unit 4. When the display console panel 1 is not used, a power generated by the solar battery 5 is charged in the rechargeable battery 7. The power charged in the rechargeable battery 7 is used as a starting power source for the control circuit 6, an operating power source for the organic EL display unit 4, an operating power source for the touch panel 3, and an operating power source for the communication circuit 8.

As shown in FIG. 1, according to the present invention, as an organic EL display unit 4 of low power consumption is used in the display device, it is possible to reduce power of the display console panel 1, thereby realizing a low power consumption. For this reason, the solar battery 5 can be used as a power source, and a power supply from an external power source can be made unnecessary.

As a touch panel is employed as a manual data input device, it is unnecessary to provide operation keys. As the touch panel can be integrated with the display panel (display device), it is possible to reduce the overall size of the console panel.

Furthermore, as the communication circuit 8 is constituted by a wireless communication circuit which exchanges data with a controller, such as a numerical control apparatus and robot controller, by wireless communication, wire connection between the controller and the display control panel is made unnecessary when the display control panel is used, allowing remote control of the controller from the display control panel.

As the organic EL display unit 4 is transparent when it is out of use, it is possible to arrange the solar battery 5 on the back of the organic EL display unit 4 for allowing power generation by the solar battery 5.

The display console panel according to the present invention is not limited to the configuration shown in FIG. 1. The display console panel can be variously modified. FIG. 3 is a schematic sectional view showing the configuration of the second embodiment of the display console panel according to the present invention.

In a display console panel 1 according to this embodiment, a touch panel 3 is accommodated in a casing 2 in a state where the touch panel 3 is exposed from the upper portion of the casing 2. Further, in the casing 2, the organic EL display unit 4 is arranged on the back of the touch panel 3, the control circuit 6 is arranged on the back of the organic EL display unit 4, and the solar battery 5 is arranged on the bottom in the casing 2. In case where the console panel is constructed as shown in FIG. 2, the display console panel is inverted when the display console panel is out of use, and then power generation is performed by the solar battery 5 arranged on the bottom of the casing 2.

FIG. 4 is a schematic sectional view showing the configuration of the third embodiment of the display console panel according to the present invention.

In a display console panel according to this embodiment, a touch panel 3 is accommodated in a casing 2 in a state where the touch panel 3 is exposed from the upper portion of the casing 2. Further, in the casing 2, the organic EL display unit 4 is arranged on the back of the touch panel 3, the control circuit 6 is arranged on the back of the organic EL display unit 4, and the solar battery 5 is arranged on a side edge of the upper surface of the casing 2.

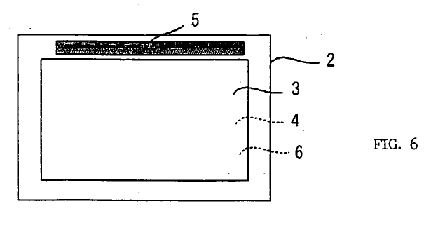

FIG. 5 is a plan view of the display console panel (third embodiment) shown in FIG. 4. FIG. 6 is a plan view showing one modification of the display console panel shown in FIG. 5. In case where the solar battery 5 is arranged in the casing 2 at the upper portion thereof, this solar battery 5 may be arranged on two opposing upper end faces of the casing 2 as shown in FIG. 5, or may be arranged on one upper end face of the casing 2 as shown in FIG. 6.

What is claimed is:

1. A display console panel for a controller, which can be connected to and communicated with a controller to exchange data with the controller, comprising:
a touch panel allowing an user to manually perform various setting operations and a data inputting operation;
an organic EL display unit for displaying data;
a solar battery for power supply generation;
a control circuit for performing a data input/output operation or display control of the organic EL display device; and
a casing to accommodate the touch panel, the organic EL display device, the solar battery, and the control circuit in piles.

2. The display console panel for a controller according to claim 1, wherein the display consol panel is used for operation of a numerical control apparatus.

3. The display console panel for a controller according to claim 1, wherein the display consol panel is used for operation of a robot controller

4. The display console panel for a controller according to claim 1, wherein the touch panel is accommodated in the casing in a state where the touch panel is exposed from an upper portion in the casing, and wherein, in the casing, the organic EL display device is arranged on the back of the touch panel, the solar battery is arranged on the back of the organic EL display device, and the control circuit is arranged on the back of the solar battery.

5. The display console panel for a controller according to claim 1, wherein the touch panel is accommodated in the casing 2 in a state where the touch panel 3 is exposed from the upper portion of the casing 2, and wherein, in the casing, the organic EL display device is arranged on the back of the touch panel, the control circuit is arranged on the back of the organic EL display device, and the solar battery is arranged on and exposed from the bottom of the casing.

6. The display console panel for a controller according to claim 1, wherein the touch panel is accommodated in the casing in a state where the touch panel is exposed from an upper portion in the casing, and wherein, in the casing, the organic EL display device is arranged on the back of the touch panel, the control circuit is arranged on the back of the organic EL display device, and the solar battery is arranged on an upper edge of the casing.

7. The display console panel for a controller according to claim 1, further comprising a communication unit which exchanges data with the controller by means of wireless communication.
